(19) United States
(12) Patent Application Publication
(10) Pub. No.: US 2013/0258929 A1
(43) Pub. Date: Oct. 3, 2013

(54) Rule-Based Application Controller for Signaling Reduction

(71) Applicant: T-MOBILE USA, INC., Bellevue, WA (US)

(72) Inventors: Pablo Tapia, Snoqualmie, WA (US); Mehul Shah, Sammamish, WA (US); Alexandru Catalin Ionescu, Bellevue, WA (US)

(73) Assignee: T-MOBILE USA, INC., Bellevue, WA (US)

(21) Appl. No.: 13/839,575

(22) Filed: Mar. 15, 2013

Related U.S. Application Data
(60) Provisional application No. 61/619,895, filed on Apr. 3, 2012.

(51) Int. Cl. H04W 52/02

(52) U.S. Cl. CPC H04W 52/0209
USPC 370/311

(57) ABSTRACT

An application controller of a telecommunication device to receive a packet from an application of the telecommunication device and determine a signaling reduction rule associated with the application is described herein. Based at least in part on the signaling reduction rule, the application controller performs a signaling reduction action associated with transmission of the packet.

### RELATED APPLICATIONS

This application claims priority to U.S. provisional patent application No. 61/619,895, entitled “Network Signaling Reduction and Battery Life Extension” and filed on Apr. 3, 2012. Application No. 61/619,895 is fully incorporated herein by this reference.

### BACKGROUND

Mobile devices, such as smart phones and netbooks are prone to make application network calls, even when not needed. Often this occurs as applications hosted on mobile devices make network calls such as checks, updates, and functions over the network. The increasing frequency of these network calls by an increasing number of applications generates significant signaling load that harms the network. Also, if a mobile device makes use of a data plan based on the volume of data transmitted and received over the network, then the application network calls constitute a charge against that data plan. Furthermore, on mobile devices, radio activity has a relatively high power draw. If a mobile device is powered by battery, the application network calls will reduce the battery lifetime between charges.

However, there are a number of scenarios where a mobile device performs an application network call that would not have resulted in a degraded user experience if the application network call had not been done at all. Such a network call would constitute an unnecessary charge against the user's data plan and an unnecessary draw against the user's battery. Also, the network call would unnecessarily consume resources of the network, such as radio frequency (RF) spectrum.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment including a telecommunication device configured with an application controller to utilize signaling reduction rules to perform signaling reduction actions, a telecommunication network, one or more application servers, a network proxy device configured with an application controller to utilize signaling reduction rules to perform signaling reduction actions, and one or more rule servers.

FIG. 2 illustrates a component level view of a telecommunication device equipped with an application controller.

FIG. 3 illustrates a component level view of a network proxy device equipped with an application controller.

FIG. 4 illustrates an example process performed by application controller of a telecommunication device, the process including receiving a packet from an application of the telecommunication device, determining a signaling reduction rule for the application, and based at least in part on the signaling reduction rule, performing a signaling reduction action associated with transmission of the packet.

FIG. 5 illustrates an example process performed by application controller of a network proxy device, the process including receiving a packet from an application server that is destined for a telecommunication device, determining a signaling reduction rule for an application of the application server, and based at least in part on the signaling reduction rule, performing a signaling reduction action associated with transmission of the packet.

### DETAILED DESCRIPTION

### Overview

This disclosure describes, in part, application controllers implemented at a telecommunication device and at a network proxy device to perform signaling reduction actions on uplink and downlink traffic, respectively. The signaling reduction actions conserve user and device resources, such as elements of a subscription plan and battery life, as well as network resources, such as RF spectrum. Example signaling reduction actions include buffering a packet for later transmission, discarding a packet, bundling a packet with one or more other packets, requesting that an application or application server wait for a time period before transmitting further packets, padding a packet to increase the size of the packet, modifying content associated with the packet (e.g., requesting that an application or application server perform compression), or triggering a radio of the telecommunication device into an active or dormant mode.

In various embodiments, the telecommunication device and network proxy device each receive or retrieve signaling reduction rules from a network operator or service provider. These signaling reduction rules are utilized by the application controllers in determining signaling reduction actions. The signaling reduction rules may be provided a single time, provided incrementally, or may be provided and then updated at intervals. The signaling reduction rules may specify one or more signaling reduction actions associated with an application or category and may, in some embodiments, associate actions with at least one or device information, network information, or user preferences. If provided by the network operator, the network operator may take into account both telecommunication device conditions and network conditions in generating and updating the signaling reduction rules.

In determining which signaling reduction action or actions to perform, the application controllers may utilize both signaling reduction rules and at least one of telecommunication device information, network information, or user preferences. The telecommunication device information may include at least one of a battery power state, an indication of whether a telecommunication display screen is on or off, or an indication of whether a telecommunication device radio is in an active mode or a dormant mode. The network information may include at least one of network congestion information, a radio channel condition, a network latency, or information associated with a cell in which the telecommunication device is located. User preferences may include a preference for application updates occurring at a certain frequency. In some embodiments, the application controllers of the telecommunication device and the network proxy device may exchange at least one of device information, network information, or user preferences with each other. In other embodiments, the application controller of the network proxy device may receive at least one of device information, network information, or user preferences from a radio interface layer (RIL) probe of the telecommunication device.

In various embodiments, the application controller of the telecommunication device may receive packets from applications of the telecommunication device and may, in response, determine application identifiers for those packets. The application controller of the telecommunication device may then utilize the application identifiers to retrieve signaling reduction rules associated with the application identifiers. An application identifier may include one or more of an internet protocol (IP) address, a communication protocol, a source port, a destination port, an application name, a signature, or a website name. In some embodiments, determining the signaling reduction rules may include mapping application identifiers to categories and categories to signaling reduction rules. The application controller of the telecommunication device may then also determine at least one of telecommunication device information, network information, or user preferences. Based on the determined signaling reduction rules and, optionally, the at least one of telecommunication device information, network information, or user preferences, the application controller of the telecommunication device performs signaling reduction actions.

The application controller of the telecommunication device may be part of the operating system of the telecommunication device or may be a layer between the applications and operating system or between the operating system and the RIL.

In some embodiments, the application controller of the network proxy device may receive a packet from an application server and may, in response, determine an application identifier for the packet. The application controller of the network proxy device may then utilize the application identifier to retrieve a signaling reduction rule associated with the application identifier. An application identifier may include one or more of an internet protocol (IP) address, a communication protocol, a source port, a destination port, an application name, a signature, or a website name. In some embodiments, determining the signaling reduction rule may include mapping the application identifier to a category and the category to a signaling reduction rule. The application controller of the network proxy device may then also determine at least one of telecommunication device information, network information, or user preferences. Based on the determined signaling reduction rule and, optionally, the at least one of telecommunication device information, network information, or user preferences, the application controller of the network proxy device performs one or more signaling reduction actions.

### Example Environment

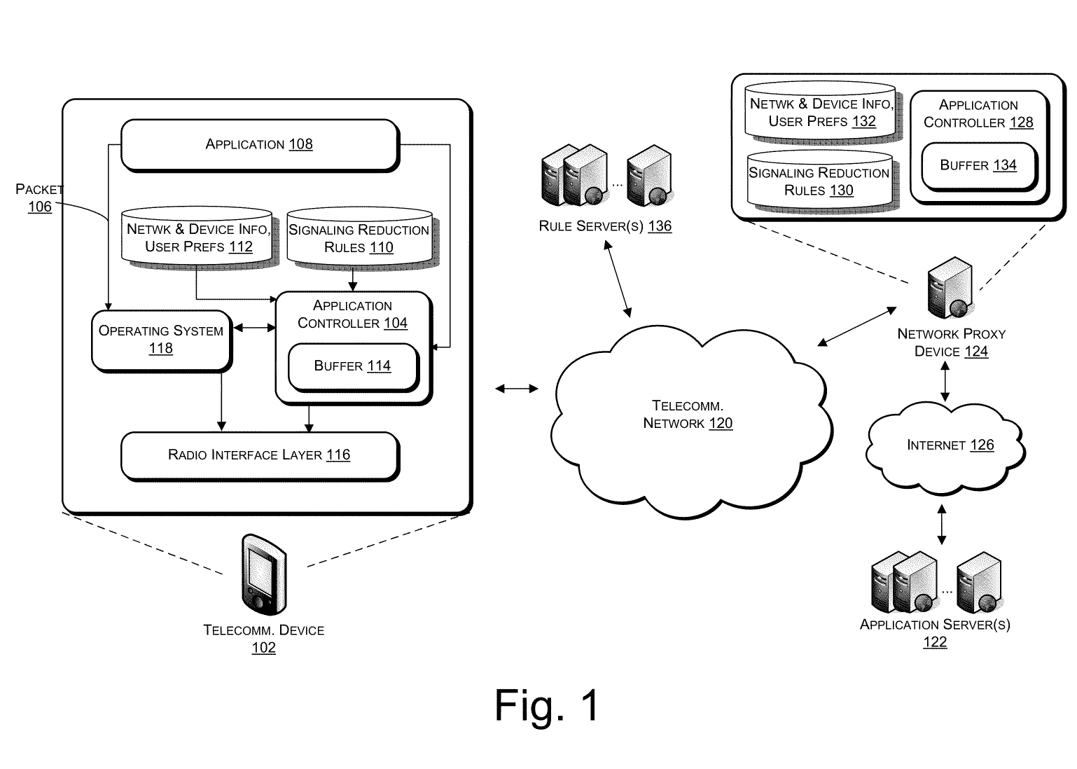

FIG. 1 illustrates an example environment including a telecommunication device configured with an application controller to utilize signaling reduction rules to perform signaling reduction actions, a telecommunication network, one or more application servers, a network proxy device configured with an application controller to utilize signaling reduction rules to perform signaling reduction actions, and one or more rule servers. As illustrated, a telecommunication device 102 may be configured with an application controller 104. The application controller 104 may receive packets 106 from one or more applications 108 of the telecommunication device 102 and may determine signaling reduction rules 110 for those packets 106. The application controller 104 may also determine at least one of device information, network information, or user preferences 112, and may utilize the signaling reduction rules 110 and the at least one of device information, network information, or user preferences 112 in selecting and performing one or more signaling reduction actions. Such actions may include, for example, buffering packet 106 in a buffer 114 of the application controller 104 or providing packets 108 in a bundle to a RIL 116 for transmission. The application controller 104 may be part of an operating system 118 of the telecommunication device, or may be a layer between the applications 108 and the operating system 118, or between the operating system 118 and the RIL 116.

The signaling reduction actions may reduce or improve the transmission of packets 106 over a telecommunication network 120 to remote recipients, such as applications servers 122. The application servers 122 may be connected to the telecommunication network 120 by a network proxy device 124 of the telecommunication network 120 and by a public network, such as the Internet 126. Because packets from the application servers 112 may also cause significant traffic to the telecommunication device 102, thereby straining network resources, and consumption of the telecommunication device's battery charge, the network proxy device 124 may also be configured with an application controller 128 to perform signaling reductions actions associated with transmission of packets from the application servers 122 to the telecommunication device 102. These signaling reduction actions may be determined based on signaling reduction rules 130 and based on at least one of device information, network information, or user preferences 132. And like the application controller 104, the application controller 128 may include a buffer 134. Also, as shown in FIG. 1, the rules server(s) 136 may be connection to the telecommunication network and may provide signaling reduction rules 110 to the telecommunication device 102 and signaling reduction rules 130 to the network proxy device 124.

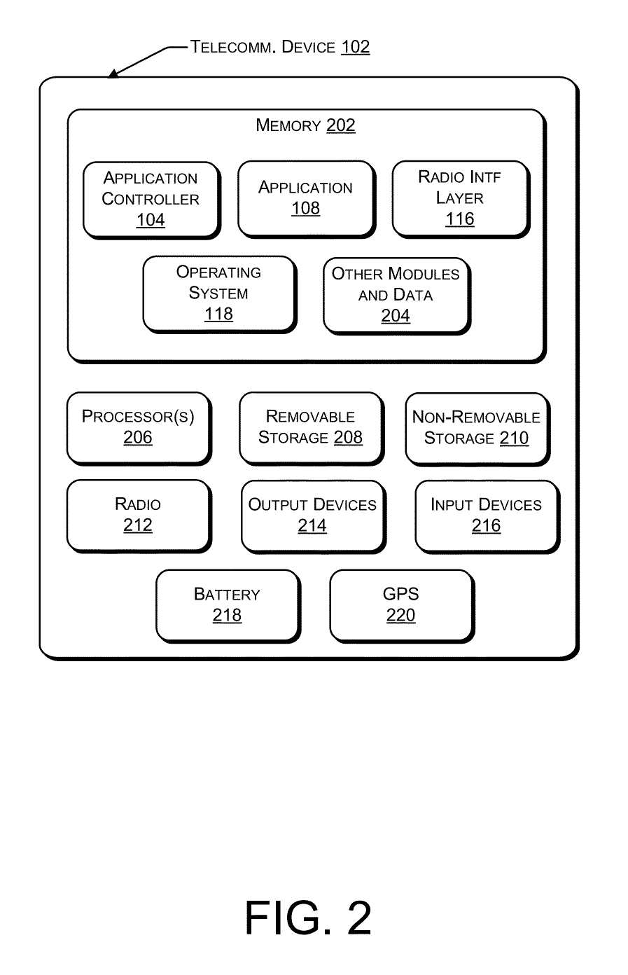

In various embodiments, the telecommunication device 102 may be any sort device capable of cellular or wireless network communication, such as a cellular phone, a tablet computer, a personal digital assistant (PDA), a personal computer (PC), a laptop computer, a media center, a work station, etc. The telecommunication device 102 may be associated with a subscription to telecommunication services of a network operator of the telecommunication network 120. An example telecommunication device 102 is illustrated in FIG. 2 and described below with reference to that figure.

The applications 108 may be any sort of network applications, such as video call clients, voice call clients, network browsers, social media clients, messaging clients, or media streaming clients. Such applications may send and receive both signaling and data in the form of packets, such as packets 106. These packets 106 may specify any or all of an IP address of a packet destination, a communication protocol, a source port of the telecommunication device 102, a destination port of the packet destination, an application name, a signature, or a website name. The applications 108 may also receive packets from a remote device, such as an application server 122. In some embodiments, the applications 108 may expose or otherwise make available any of device information, network information, or user preferences 112.

In some embodiments, the operating system 118 may be any sort of telecommunication device operating system, such as an iOS®, an Android® operating system, a Windows® operating system, or a Unix-based operating system. The operating system 118 may also include the application controller 104 as, for example, a modification of a kernel of the operating system 118. In some embodiments, the operating system 118 may expose or otherwise make available any of device information, network information, or user preferences 112.

The RIL 116 may be an RIL of a network stack and may service as an interface to a radio of the telecommunication device 102. The RIL 116 may support a number of radio bearers for different packet flows, applications 108, or categories of applications 108. The radio bearers of RIL 116 may further receive packets 106, either from the operating system 118 or from the application controller 104, and may transmit the packets 106 over the telecommunication network 120 via the radio of the telecommunication device 102. The radio bearers may also receive inbound packets associated with their respective packet flows or applications 108 and may provide those inbound packets to the applications 108. In some embodiments, the RIL 116 may further include a probe that is configured to provide at least one of device information, network information, or user preferences 112 to a network proxy device 124 of the telecommunication network 120.

In various embodiments, the signaling reduction rules 110 may be stored locally on the telecommunication device 102 or remotely. The signaling reduction rules 110 may be stored in a database, file, collection, or other data structure. In one embodiment, they may be specified in an extensible markup language (XML) file. The telecommunication device 102 receives or retrieves the signaling reduction rules 110 from a network operator or service provider. The one or more rules servers 136 illustrated in FIG. 1 may be associated with the network operator or service provider. The signaling reduction rules 110 may be provided a single time, provided incrementally, or may be provided and then updated at intervals. The signaling reduction rules 110 may specify any one or more signaling reduction actions associated with an application identifier or category. In addition to being associated with an application identifier or category, each signaling reduction rule 110 may be associated with any or one more items of device information, items of network information, or user preferences 112. Example signaling reduction actions associated with signaling reduction rules 110 are described in further detail herein. The rules server(s) 136 may take into account at least one of telecommunication device conditions (e.g., device information 112), network conditions (e.g., network information 112) or user preferences 112 in generating and updating the signaling reduction rules 110. For example, the rules server(s) 136 may generate two different signaling reduction rules 110 for a same application 108, each rule associated with a different cell of the telecommunication network 120. Further, the signaling reduction rules 110 may be associated with a user subscription level, as the rules server(s) 136 may generate different sets of signaling reduction rules for different subscription levels with (e.g., more expensive subscription levels may be associated with less buffering time).

The device information, network information, or user preferences 112 may be retrieved or compiled from any source, such as applications 108, operating system 118, RIL 118, network proxy device 124, or another device of the telecommunication network 120. The device information, network information, or user preferences 112 may be retrieved or compiled by the application controller 104, by the network proxy device 124, or by another component of the telecommunication device 102 or another device. The device information 112 may include at least one of a battery power state, an indication of whether a telecommunication display screen is on or off, or an indication of whether a telecommunication device radio is in an active mode or a dormant mode. The network information 112 may include at least one of network congestion information, a radio channel condition, a network latency, or information associated with a cell in which the telecommunication device is located. User preferences 112 may include a preference for application updates occurring at a certain frequency, which may be related to the delay responses associated with the respective applications.

As mentioned above, the application controller 104 may be part of the operating system 118. Alternatively, the application controller 104 may be a layer, such as a layer in a network stack. In such embodiments, that layer may be between the applications 108 and the operating system 118 or between the operating system 118 and RIL 116. Regardless of whether it is incorporated in operating system 118 or is a layer, the application controller 104 is in the communication path from applications 108 to the RIL 116.

In various embodiments, the application controller 104 receives or traps packets 106 provided by the applications 108 for transmission via the radio of the telecommunication device 102. Upon receiving a packet 106, the application controller 104 determines the application identifier of the packet 106. The application identifier may include one or more of an internet protocol (IP) address, a communication protocol, a source port, a destination port, an application name, a signature, or a website name. The application controller 104 then utilizes the application identifier of the packet 106 to retrieve a signaling reduction rule 110 from the set of signaling reduction rules 110. To retrieve the signaling reduction rule 110, the application controller 104 may utilize mappings of application identifiers to signaling reduction rules 110 or mappings of application identifiers to categories and categories to signaling reduction rules 110. As mentioned, the signaling reduction rules 110 may be stored locally on the telecommunication device 102 or remotely at, for example, rules server(s) 136. In some embodiments, no signaling reduction rule 110 may be associated with the application identifier of the packet 106. In such embodiments, the application controller 104 may simply provide the packet 106 to the RIL 116 for transmission. In further embodiments, rather than performing these actions (e.g., retrieving signaling reduction rules 110) for each packet 106, the application controller 104 may perform the actions once for a packet flow that includes the packet 106.

In some embodiments, the application controller 104 may further retrieve any of or more of device information, network information, or user preferences 112 from any source, such as applications 108, operating system 118, RIL 118, network proxy device 124, or another device of the telecommunication network 120. Examples of device information, network information, or user preferences 112 are described further herein. In some embodiments, the application controller 104 of the telecommunication device 102 and the application controller 128 of the network proxy device 124 may exchange at least one of device information, network information, or user preferences 112 with each other.

The retrieved signaling reduction rule 110 specifies one or more signaling reduction actions, and the application controller 104 select at least one of those one or more signaling reduction actions to perform, in some embodiments based on or more of device information, network information, or user preferences 112. The application controller 104 may then perform the at least one selected signaling reduction action. For example, the application controller 104 may buffer the packet 106 and/or packets of the packet flow including packet 106 for later transmission, storing that packet 106/packet flow in a buffer 114 of the application controller 104. Also or instead, the application controller 104 may discard the packet 106/packet flow, bundle the packet 106/packet flow with one or more other packets 106/packet flows, request that an application 108 wait for a time period before transmitting further packets 106/packet flows, pad the packet 106/packets of the packet flow to increase the size of the packet 106/packets, modify content associated with the packet 106/packets of the packet flow (e.g., requesting that an application 108 perform compression), or trigger a radio of the telecommunication device 102 into an active or dormant mode. In some embodiments, such as those where the packet 106/packet flow has been buffered, bundled, padded, or modified, the application controller 104 may then provide the packet 106/packet flow to the RIL 116 for transmission.

The telecommunication network 120 may be a telecommunication network of a telecommunication service provider that provides a plan or services to the telecommunication device 102. The telecommunication network 120 may include a core network and a plurality of access networks that are associated with base stations, nodeBs, eNodeBs, or other access points. In some embodiments, the network proxy device 124 may be an edge device of the core network and may communicate with another device of the core network, such as a gateway GPRS (general packet radio service) support node (GGSN), a serving gateway (SGW), or packet data network gateway (PGW). The access networks of the telecommunication network 120 may each be associated with a specific geographic area (e.g., a cell, a macrocell, a microcell, a femtocell, etc.). In some embodiments, the telecommunication network 120 may be a cellular network having spectrum to allocate for cellular communications. Because that spectrum is a scare resource, signaling reduction by application controllers 104 and 128 on uplink and downlink transmissions is important in making sure that spectrum is optimally used.

In various embodiments, the application server(s) 122, network proxy device 124, and rule server(s) 136 may each be or include a server or server farm, multiple, distributed server farms, a mainframe, a work station, a personal computer (PC), a laptop computer, a tablet computer, an embedded system, or any other sort of device or devices. In one implementation, one or more of the application server(s) 122, network proxy device 124, and rule server(s) 136 represent a plurality of computing devices working in communication, such as a cloud computing network of nodes.

The application server(s) 122 may be associated with any sort of network application and may provide services to any number of remote clients, such as application 108. For example the application server(s) 108 may be video call server(s), voice call server(s), web server(s), social media server(s), messaging server(s), or media streaming server(s). The application server(s) 108 may receive packets 106 and may respond to those received communications. In some embodiments, the application server(s) 122 may be connected to an edge device of the telecommunication network 120, such as a network proxy device 124, via a public network, such as the Internet 126.

As mentioned above, the network proxy device 124 may be an edge device of the telecommunication network 120 between other devices of the telecommunication network 120, such as a GGSN, SGW, or PGW, and a public network, such as the Internet 126. The network proxy device 124 is configured with an application controller 128 to perform signaling reduction actions associated with the transmission of packets across the telecommunication network 120 to the telecommunication device 102, thereby conserving resources of both the telecommunication device 102 and of the telecommunication network 120.

In various embodiments, the application controller 128 may perform the signaling reduction functions for downlink communications that the application controller 104 performs for uplink communications. The application controller 128 receives or traps packets received from, e.g., the application server(s) 122 for transmission to the telecommunication device 102. Upon receiving a packet, the application controller 128 determines the application identifier of the packet. The application identifier may include one or more of an internet protocol (IP) address, a communication protocol, a source port, a destination port, an application name, a signature, or a website name. The application controller 128 then utilizes the application identifier of the packet to retrieve a signaling reduction rule 130 from the set of signaling reduction rules 130. The set of signaling reduction rules 130 may be similar to or the same as the above-described set of signaling reduction rules 110. To retrieve the signaling reduction rule 130, the application controller 128 may utilize mappings of application identifiers to signaling reduction rules 130 or mappings of application identifiers to categories and categories to signaling reduction rules 130. The signaling reduction rules 130 may be stored locally on the network proxy device 124 or remotely at, for example, rules server(s) 136. In some embodiments, no signaling reduction rule 130 may be associated with the application identifier of the packet. In such embodiments, the application controller 128 may simply transmit the packet across the telecommunication network 120 to its destination telecommunication device 102.

In some embodiments, the application controller 128 may further retrieve any of or more of device information, network information, or user preferences 132 from any source, such as telecommunication device 102, another device of the telecommunication network 120, or specialized server(s) (e.g., network congestion information may be provided by specialized server(s)). Device information, network information, and user preferences 132 may be similar to, or the same as, device information, network information, and user preferences 112, and examples of device information, network information, or user preferences 112 are described further herein. In some embodiments, the application controller 128 of the network proxy device 124 and the application controller 104 of the telecommunication device 102 may exchange at least one of device information, network information, or user preferences 132 with each other. In further embodiments, the application controller 128 of the network proxy device 124 may receive at least one of device information, network information, or user preferences 132 from a RIL probe of the telecommunication device 102.

The retrieved signaling reduction rule 130 specifies one or more signaling reduction actions, and the application controller 128 selects at least one of those one or more signaling reduction actions to perform, in some embodiments based on or more of device information, network information, or user preferences 132. The application controller 128 may then perform the at least one selected signaling reduction action. For example, the application controller 128 may buffer the packet or other packets of a packet flow that includes the packet for later transmission, storing that packet/packet flow in a buffer 134 of the application controller 128. Also or instead, the application controller 128 may discard the packet/packet flow, bundle the packet/packet flow with one or more other packets/packet flows, request that an application server 122 wait for a time period before transmitting further packets/packet flows, pad the packet/packets to increase the size of the packet/packets, modify content associated with the packet/packets (e.g., requesting that an application server 122 perform compression), or trigger a radio of the telecommunication device 102 into an active or dormant mode.

In some embodiments, the rule server(s) 136 may be devices of the network operator or service provider associated with the telecommunication network 120. As mentioned, the signaling reduction rules 110 specified by the rule server(s) 136 may be specific to an application 108 or a category of applications 108. Also, signaling reduction rules 110 may be associated with specific sectors of the telecommunication network 120 and may be updated by the rule server(s) 136 based on changing conditions, such as server failures or security exploits. In addition, the signaling reduction rules may be specific to any one or more of device information 112, network information 112, user preferences 112, or a subscription plan associated with a user of the telecommunication device 102. The rule server(s) 136 may receive network information, such as congestion conditions at cells, from the telecommunication network 120. The rule server(s) 136 may also receive device information from the telecommunication device 102 (e.g., from the application controller 104) or from the telecommunication network 120 (e.g., from the application controller 128 of the network proxy device 124). The rule server(s) 136 may utilize the network information and device information in formulating signaling reduction rules 110 or updates to signaling reduction rules 110.

In some embodiments, specification or updating of signaling reduction rules 110 may be triggered by the telecommunication network 120. As mentioned above, the signaling reduction rules 110 may specify signaling reduction actions. The may also each be associated with an application identifier, either in the set of signaling reduction rules 110 itself or in an accompanying table or structure. In embodiments where rules are associated with categories, the rule server(s) 136 may generate a further mapping of application identifiers to categories, and associate categories with signaling reduction rules 110. The signaling reduction rules 110 may be provided periodically or responsive to the generating or updating or signaling reduction rules 110. In one embodiment, the signaling reduction rules 110 are stored at the rule server(s) 136, and the application controller 104 may retrieve specific signaling reduction rules 110 by providing an application identifier and, optionally an indication of device information, network information, or user preferences 112.

### Example Devices

FIG. 2 illustrates a component level view of a telecommunication device equipped with an application controller. As illustrated, the telecommunication device 102 comprises a system memory 202 storing the application controller 104, the applications 108, the radio interface layer 116, the operating system 118, and other modules and data 204. Also, the telecommunication device 102 includes processor(s) 206, a removable storage 208, a non-removable storage 210, radio 212, output device(s) 214, and input device(s) 216.

In various embodiments, system memory 202 is volatile (such as RAM), non-volatile (such as ROM, flash memory, etc.) or some combination of the two. The application controller 104, the applications 108, the radio interface layer 116, and the operating system 118 are described above in detail with regard to FIG. 1. The other modules or data 204 stored in the system memory 202 may comprise any sort of applications or platform components of the telecommunication device 102, as well as data associated with such applications or platform components.

In some embodiments, the processor(s) 206 is a central processing unit (CPU), a graphics processing unit (GPU), or both CPU and GPU, or any other sort of processing unit.

Telecommunication device 102 also includes additional data storage devices (removable and/or non-removable) such as, for example, magnetic disks, optical disks, or tape. Such additional storage is illustrated in FIG. 2 by removable storage 208 and non-removable storage 210. Tangible computer-readable media may include volatile and nonvolatile, removable and non-removable media implemented in any method or technology for storage of information, such as computer readable instructions, data structures, program modules, or other data. System memory 202, removable storage 208 and non-removable storage 210 are all examples of computer-readable storage media. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the telecommunication device 102. Any such tangible computer-readable media may be part of the telecommunication device 102.

In some embodiments, the radio 212 includes any sort of radio known in the art. For example, radio 212 may include a radio transceiver that performs the function of transmitting and receiving radio frequency communications via an antenna. The radio 212 may facilitate wireless connectivity between the telecommunication device 102 and various cell towers, base stations and/or access points of the telecommunication network 120. In addition to radio 212, the telecommunication device 102 may also include a wireless communication transceiver and a near field antenna for communicating over unlicensed wireless IP networks, such as local wireless data networks and personal area networks (e.g., Bluetooth or near field communication (NFC) networks).

In some embodiments, the output devices 214 include any sort of output devices known in the art, such as a display (e.g., a liquid crystal display), speakers, a vibrating mechanism, or a tactile feedback mechanism. Output devices 214 also include ports for one or more peripheral devices, such as headphones, peripheral speakers, or a peripheral display.

In various embodiments, input devices 216 include any sort of input devices known in the art. For example, input devices 216 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

In some embodiments, the battery 218 may be any sort of battery, such as a lithium ion battery. The battery 218 may be rechargeable, and may be associated with logic of the telecommunication device 102 capable of exposing a charge level of the battery 218 to a platform or applications of the telecommunication device 102, such as the application controller 104.

The GPS 220 may be functionality and logic capable of wirelessly communicating with a GPS system to receive GPS locations, such as GPS coordinates, from the GPS system. The GPS 220 may expose those GPS locations to a platform or applications of the telecommunication device 102, such as the application controller 104.

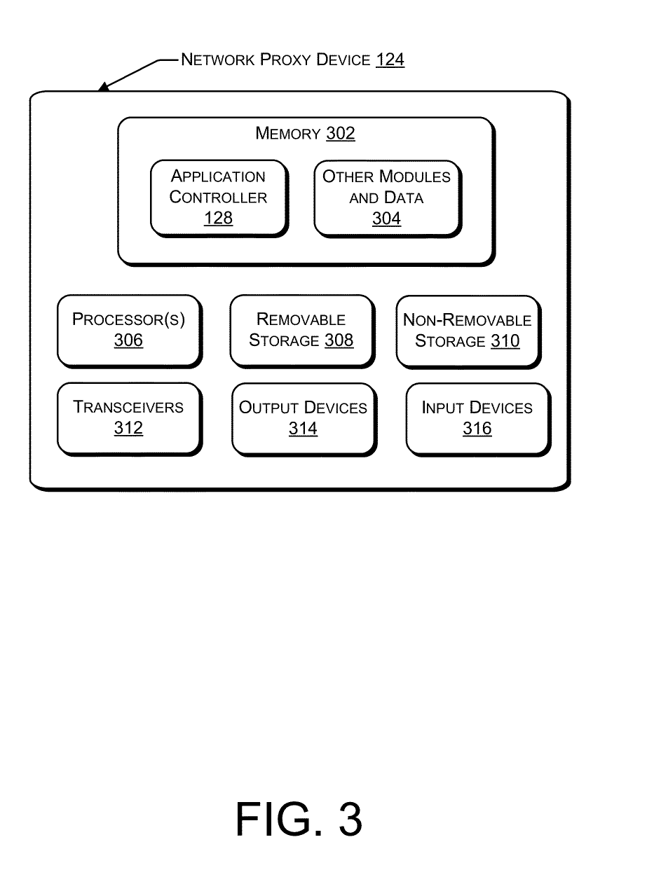

FIG. 3 illustrates a component level view of a network proxy device equipped with an application controller. As illustrated, the network proxy device 124 comprises a system memory 302 storing the application controller 128 and other modules and data 304. Also, the network proxy device 124 includes processor(s) 306, a removable storage 308, a non-removable storage 310, transceivers 312, output device(s) 314, and input device(s) 316.

In various embodiments, system memory 302 is volatile (such as RAM), non-volatile (such as ROM, flash memory, etc.) or some combination of the two. The application controller 128 is described above in detail with regard to FIG. 1. The other modules or data 304 stored in the system memory 302 may comprise any sort of applications or platform components of the network proxy device 124, as well as data associated with such applications or platform components.

In some embodiments, the processor(s) 306 is a central processing unit (CPU), a graphics processing unit (GPU), or both CPU and GPU, or any other sort of processing unit.

Network proxy device 124 also includes additional data storage devices (removable and/or non-removable) such as, for example, magnetic disks, optical disks, or tape. Such additional storage is illustrated in FIG. 3 by removable storage 308 and non-removable storage 310. Tangible computer-readable media may include volatile and nonvolatile, removable and non-removable media implemented in any method or technology for storage of information, such as computer readable instructions, data structures, program modules, or other data. System memory 302, removable storage 308 and non-removable storage 310 are all examples of computer-readable storage media. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the network proxy device 124. Any such tangible computer-readable media may be part of the network proxy device 124.

In some embodiments, the transceivers 312 include any sort of transceivers known in the art. For example, transceivers 312 may include a radio transceiver that performs the function of transmitting and receiving radio frequency communications via an antenna. The radio 212 may facilitate wireless connectivity between the network proxy device 124 and various nodes of the telecommunication network 120 or between the network proxy device 124 and routers or other devices of the Internet 126. In addition, the transceivers 312 may also include a wireless communication transceiver and a near field antenna for communicating over unlicensed wireless IP networks, such as local wireless data networks and personal area networks (e.g., Bluetooth or near field communication (NFC) networks). Further, the transceivers 312 may include wired communication components, such as an Ethernet port, that connect the network proxy device 124 in a wired fashion to one or more nodes of the telecommunication network 120 and routers or other devices of the Internet 126.

In some embodiments, the output devices 314 include any sort of output devices known in the art, such as a display (e.g., a liquid crystal display), speakers, a vibrating mechanism, or a tactile feedback mechanism. Output devices 314 also include ports for one or more peripheral devices, such as headphones, peripheral speakers, or a peripheral display.

In various embodiments, input devices 316 include any sort of input devices known in the art. For example, input devices 316 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

### Example Processes

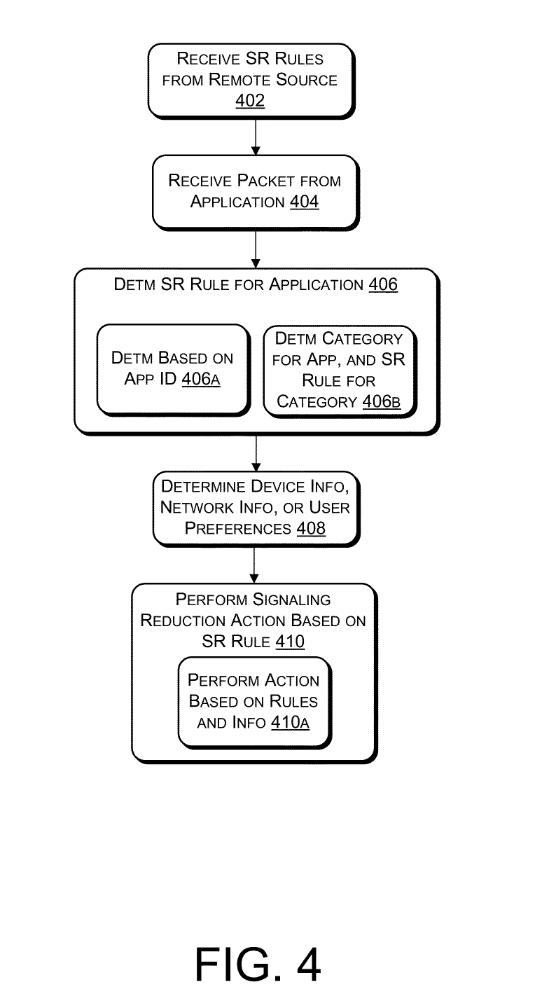

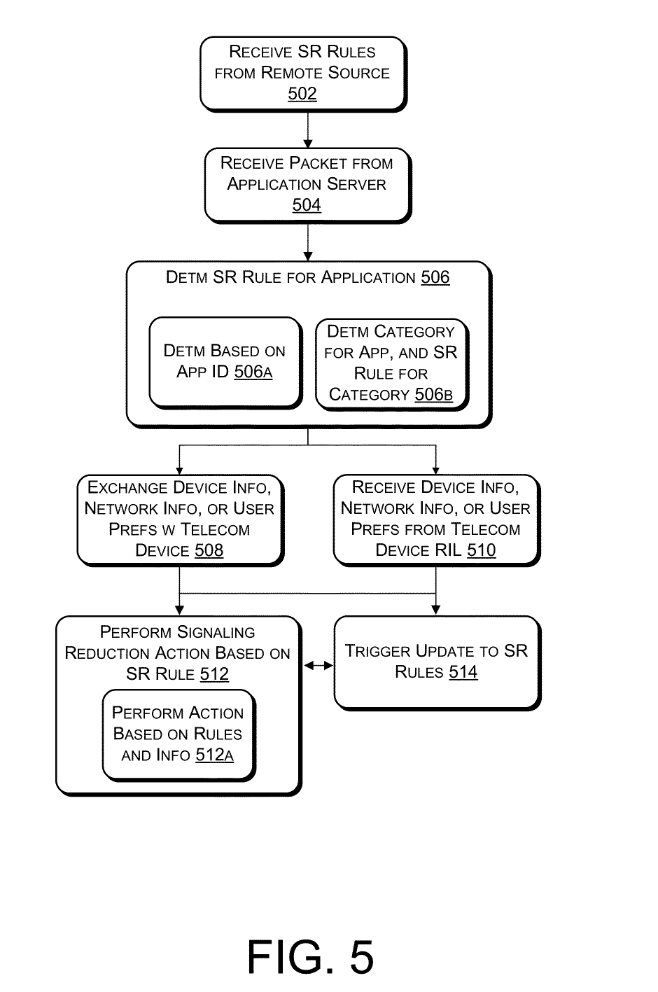

FIGS. 4 and 5 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 4 illustrates an example process performed by application controller of a telecommunication device, the process including receiving a packet from an application of the telecommunication device, determining a signaling reduction rule for the application, and based at least in part on the signaling reduction rule, performing a signaling reduction action associated with transmission of the packet. The process includes, at 402, receiving or retrieving, by a telecommunication device, a set of signaling reduction rules from a network operator or service provider. The set of signaling reduction rules may be generated by the network operator or the service provider based on observation of activities of telecommunication device applications. Each signaling reduction rule may specify one or more signaling reduction actions, each specified signaling reduction action associated with one or more device conditions, network conditions, or user preferences.

At 404, the application controller of the telecommunication device receives a packet from an application of the telecommunication device. In response, at 406, the application controller determines a signaling reduction rule associated with the application. At 406a, the determining comprises retrieving the signaling reduction rule from a set of signaling reduction rules based on an application identifier associated with the application. The application identifier includes one or more of an internet protocol (IP) address, a communication protocol, a source port, a destination port, an application name, a signature, or a website name. At 406b, the determining comprises determining a category associated with the application and determining a signaling reduction rule that is associated with the category.

At 408, the application controller determines at least one of device information, network information, or user preferences. The device information may include at least one of a battery power state, an indication of whether a telecommunication display screen is on or off, or an indication of whether the radio is in an active mode or a dormant mode. The network information may include at least one of network congestion information, a radio channel condition, a network latency, or information associated with a cell in which the telecommunication device is located.

At 410, based at least on the determined signaling reduction rule, the application controller performs a signaling reduction action associated with the transmission of the packet. The signaling reduction action may be one of buffering the packet for later transmission, discarding the packet, bundling the packet with one or more other packets, requesting that the application wait for a time period before transmitting further packets, padding the packet to increase the size of the packet, modifying content associated with the packet, or triggering a radio of the telecommunication device into an active or dormant mode. At 410a, the performing may be based both on the signaling reduction rule and on the at least one of the device information, the network information, or the user preferences.

FIG. 5 illustrates an example process performed by application controller of a network proxy device, the process including receiving a packet from an application server that is destined for a telecommunication device, determining a signaling reduction rule for an application of the application server, and based at least in part on the signaling reduction rule, performing a signaling reduction action associated with transmission of the packet. The process includes, at 502, receiving or retrieving, by a network proxy device, a set of signaling reduction rules from a network operator or service provider. The set of signaling reduction rules may be generated by the network operator or the service provider based on observation of activities of telecommunication device applications. Each signaling reduction rule may specify one or more signaling reduction actions, each specified signaling reduction action associated with one or more device conditions, network conditions, or user preferences.

At 504, the application controller of the network proxy device receives a packet from an application server that is destined for a telecommunication device. In response, at 506, the application controller determines a signaling reduction rule associated with an application of the application server. At 506a, the determining comprises retrieving the signaling reduction rule from a set of signaling reduction rules based on an application identifier associated with the application. The application identifier includes one or more of an internet protocol (IP) address, a communication protocol, a source port, a destination port, an application name, a signature, or a website name. At 506b, the determining comprises determining a category associated with the application and determining a signaling reduction rule that is associated with the category.

At 508, the application controller may exchange at least one of device information, network information, or user preferences with an application controller of the telecommunication device.

At 510, the application controller may receive at least one of device information, network information, or user preferences from a radio interface layer probe of the telecommunication device.

At 512, based at least on the determined signaling reduction rule, the application controller performs a signaling reduction action associated with the transmission of the packet. The signaling reduction action may be one of buffering the packet for later transmission, discarding the packet, bundling the packet with one or more other packets, requesting that the application server wait for a time period before transmitting further packets, padding the packet to increase the size of the packet, modifying content associated with the packet, or triggering a radio of the telecommunication device into an active or dormant mode. At 512a, the performing may be based both on the signaling reduction rule and on the at least one of the device information, the network information, or the user preferences.

At 514, the application controller may trigger an update to a set of signaling reduction rules based at least in part on telecommunication device information, network information, or user preferences.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A telecommunication device comprising:
a processor;
an application configured to be operated by the processor to transmit a network packet;
an application controller configured to be operated by the processor to:
receive the network packet from the application,
determine a signaling reduction rule associated with the application,
determine at least one of device information, network information, or user preferences, and
based at least in part on the signaling reduction rule and the at least one of the device information, the network information, or the user preferences, perform a signaling reduction action associated with transmission of the network packet,
wherein the signaling reduction action is one of buffering the network packet for later transmission, discarding the network packet, bundling the network packet with one or more other network packets, requesting that the application wait for a time period before transmitting further network packets, padding the network packet to increase the size of the network packet, modifying content associated with the network packet, or triggering a radio of the telecommunication device into an active or dormant mode.

2. The telecommunication device of claim 1, wherein the application controller is part of an operating system of the telecommunication device or is a layer that is between the application and the operating system or is between the operating system and a radio interface layer of the telecommunication device.

3. The telecommunication device of claim 1, further comprising a buffer of the application controller configured to store network packets for a time period.

4. A method comprising:
receiving, by an application controller of a telecommunication device, a packet from an application of the telecommunication device;
determining, by the application controller of the telecommunication device, a signaling reduction rule associated with the application; and
based at least in part on the signaling reduction rule, performing, by the application controller of the telecommunication device, a signaling reduction action associated with transmission of the packet.

5. The method of claim 4, further comprising determining at least one of device information, network information, or user preferences.

6. The method of claim 5, wherein the device information includes at least one of a battery power state, an indication of whether a telecommunication display screen is on or off, or an indication of whether the radio is in an active mode or a dormant mode.

7. The method of claim 5, wherein the network information includes at least one of network congestion information, a radio channel condition, a network latency, or information associated with a cell in which the telecommunication device is located.

8. The method of claim 5, wherein performing the signaling reduction action is based both on the signaling reduction rule and on the at least one of the device information, the network information, or the user preferences.

9. The method of claim 4, wherein the determining comprises retrieving the signaling reduction rule from a set of signaling reduction rules based on an application identifier associated with the application.

10. The method of claim 9, wherein the application identifier includes one or more of an internet protocol (IP) address, a communication protocol, a source port, a destination port, an application name, a signature, or a website name.

11. The method of claim 4, wherein determining the signaling reduction rule comprises determining a category associated with the application and determining a signaling reduction rule that is associated with the category.

12. The method of claim 4, further comprising receiving a set of signaling reduction rules that includes the signaling reduction rule from a network operator or service provider.

13. The method of claim 12, wherein the set of signaling reduction rules are generated by the network operator or the service provider based on observation of activities of telecommunication device applications.

14. The method of claim 4, wherein the signaling reduction rule specifies one or more signaling reduction actions, each specified signaling reduction action associated with one or more device conditions, network conditions, or user preferences.

15. The method of claim 4, wherein the signaling reduction action is one of buffering the packet for later transmission, discarding the packet, bundling the packet with one or more other packets, requesting that the application wait for a time period before transmitting further packets, padding the packet to increase the size of the packet, modifying content associated with the packet, or triggering a radio of the telecommunication device into an active or dormant mode.

16. One or more computer storage devices having stored thereon computer-executable instructions configured to program a network proxy device of a telecommunication network to perform operations comprising:
receiving, by an application controller, a packet from an application server, the packet being destined for a telecommunication device;
determining, by the application controller, a signaling reduction rule associated with an application of the application server; and
based at least in part on the signaling reduction rule, performing, by the application controller, a signaling reduction action associated with transmission of the packet.

17. The one or more computer storage devices of claim 16, wherein the operations further comprise exchanging at least one of device information, network information, or user preferences with an application controller of the telecommunication device.

18. The one or more computer storage devices of claim 16, wherein the operations further comprise receiving at least one of device information, network information, or user preferences from a radio interface layer probe of the telecommunication device.

19. The one or more computer storage devices of claim 16, wherein the operations further comprise performing the signaling reduction action based both on the signaling reduction rule and on the at least one of device information, network information, or user preferences.

20. The one or more computer storage devices of claim 16, wherein the signaling reduction action is one of buffering the packet for later transmission, discarding the packet, bundling the packet with one or more other packets, requesting that the application server wait for a time period before transmitting further packets, padding the packet to increase the size of the packet, modifying content associated with the packet, or triggering a radio of the telecommunication device into an active or dormant mode.

21. The one or more computer storage devices of claim 16, wherein the operations further comprise triggering an update to a set of signaling reduction rules based at least in part on telecommunication device information, network information, or user preferences.

22. The one or more computer storage devices of claim 16, wherein the signaling reduction rule belongs to one of a plurality of sets of signaling reduction rules respectively associated with a plurality of subscription plans.
